(19) United States
(12) Patent Application Publication
(10) Pub. No.: US 2004/0036929 A1
(43) Pub. Date: Feb. 26, 2004

(54) Image forming apparatus and image forming system

(75) Inventor: Takehiro Yamakawa, Yamanashi-ken (JP)

Correspondence Address: KANESAKA AND TAKEUCHI, Suite 2, 1423 Powhatan Street, Alexandria, VA, 22314, US

(73) Assignee: NISCA CORPORATION

(21) Appl. No.: 10/615,903

(22) Filed: Jul. 10, 2003

(30) Foreign Application Priority Data
Aug. 23, 2002 (JP) 2002-243327

(51) Int. Cl. H04N 1/04

(52) U.S. Cl. 358/498; 358/474

(57) ABSTRACT

An image forming apparatus includes a sheet feeding unit for feeding a manuscript sheet and insert sheet composed of a cover or an interleave, an image reading device for reading an image on the sheet fed from the sheet feeding unit, a sheet determining device for determining whether the sheet conveyed to the image reading device is the manuscript sheet or the insert sheet, and an image forming unit for forming an image on a copy sheet according to image data read by the image reading device. The image reading device is controlled to perform a reading operation only when the sheet determining device determines the manuscript sheet.

### BACKGROUND OF THE INVENTION AND RELATED ART STATEMENT

The present invention relates to an image forming apparatus and an image forming system having a function of inserting a cover, an interleaf, or the like in between sheets when copying an original.

As a conventional image forming apparatus, as shown in FIG. 10, a copying machine 1 includes a manuscript sheet feeding unit (part) 2 for feeding manuscript sheets, a copy sheet feeding unit (part) 3 for feeding copy sheets, image reading means 4 provided with an optical sensor for reading an image on the manuscript sheet conveyed one by one from the manuscript sheet feeding unit 2, an image forming unit (part) 5 for transferring the image on the manuscript sheet read by the image reading means 4 to the copy sheet to form the image on the copy sheet, and a sheet discharge unit (ejection part) 6 for discharging the copy sheet with the image formed by the image forming unit 5 and the manuscript sheet.

When the copying machine 1 copies a large number of manuscripts, there are some cases where a cover needs to be attached to every manuscript or interleaves need to be inserted between the pages for binding. In such cases, an inserter 11 is mounted on the conventional copying machine 1 for feeding the insert sheets such as covers, interleaves, or the like. The inserter 11 is provided with an insert sheet feeding unit (part) 12, which functions in substantially the same manner as the manuscript sheet feeding unit 2 of the copying machine 1. The insert sheet feeding unit 12 is connected to the sheet discharge unit 6 in the copying machine 1. A control mechanism (not shown) or a manual operation controls timing when the insert sheets inserted in the sheet discharge unit 6 are forwarded.

Several inserters with a modified sheet feeding mechanism or an improved control have been disclosed. For example, Japanese Patent Publication (Tokkai) No. 2001-26367 has disclosed an image forming apparatus in which a sheet feeding mechanism is capable of conveying a large-sized insert sheet smoothly to a sheet discharge unit, and a control of the mechanism is improved.

However, such a conventional image forming apparatus has the following disadvantages. That is, the manuscript sheet feeding unit 2 for feeding and conveying the manuscript sheets and the inserter 11 for feeding and conveying the insert sheets such as covers, interleaves, or the like are provided separately as shown in FIG. 10. Accordingly, it is necessary to separately provide a manuscript sheet conveyance path for guiding the manuscript sheets and an insert sheet conveyance path for guiding the insert sheets. Therefore, it is difficult to reduce a size of a whole copying machine (image forming apparatus).

Further, trays for stacking the manuscript sheets and insert sheets are disposed separately away from each other. As a result, it is difficult to supply and replenish the manuscript sheets and insert sheets.

In view of the problems described above, it is an object of the invention to provide an image forming apparatus in which sheets are read and fed regardless of the situation that the sheets are manuscript sheets or insert sheets, such as covers, interleaves, or the like, inserted between the sheets with images formed thereon. As a result, it is possible to make a space for feeding and conveying the sheets compact.

It is another object of the invention to provide an image forming system in which an automatic sheet feeding unit and/or an automatic sheet discharge unit attached to an image forming apparatus have a function of feeding and conveying the insert sheets. Accordingly, it is possible to obtain an improved flexibility in combination and an ability of expansion.

Further objects and advantages of the invention will be apparent from the following description of the invention.

### SUMMARY OF THE INVENTION

In order to solve the problems described above, according to the present invention, an image forming apparatus includes a sheet feeding unit for feeding manuscript sheets and insert sheets composed of covers or interleaves; image reading means for reading an image on the sheet fed from the sheet feeding unit; an image forming unit for forming an image on a copy sheet according to image data read by the image reading means; and a sheet discharge unit for discharging the manuscript sheets, copy sheets, and insert sheets.

In the present invention, the sheet feeding unit and a conveyance path are provided in common for the manuscript sheets and insert sheets. Therefore, it is possible to reduce a size of the entire image forming apparatus.

Further, according to the present invention, sheet determining means is provided for determining whether the sheet fed from the sheet feeding unit is the manuscript sheet or the insert sheet. Therefore, it is possible to supply the manuscript sheets and insert sheets to the single sheet feeding unit in a mixed state. Also, the image reading means reads the image only when the sheet determining means determines that the sheet fed from the sheet feeding unit is the manuscript sheet. Accordingly, it is possible to eliminate unnecessary reading and achieve high speed processing.

Further, according to the present invention, the sheet determining means includes operation means for selecting the manuscript sheets and the insert sheets among the sheets. Therefore, an operator can determine whether the image needs to be read according to visual observation of a state of feeding the sheets.

According to the present invention, it is arranged that the manuscript sheets and insert sheets fed from the sheet feeding unit are discharged to respective sheet discharge units via separate conveyance paths provided in the image forming apparatus. Therefore, it is possible to select processes for the manuscript sheets and insert sheets readily and surely.

According to the present invention, the sheet feeding unit includes a sheet feeding tray for receiving the manuscript sheets and insert sheets, and sheet separating means for separating the manuscript sheets or insert sheets one by one. Therefore, it is possible to determine and process the manuscript sheets and insert sheets reliably and easily.

Further, according to the present invention, an image forming system includes an image forming apparatus for reading the image on the manuscript sheet and forming the image on the copy sheet; and an attachment attached to the image forming apparatus and having a sheet feeding unit for feeding the manuscript sheets and insert sheets, and image reading means for reading the image on the sheet fed from the sheet feeding unit.

In the invention, the attachment includes the sheet feeding unit for feeding the manuscript sheets and insert sheets, and image reading means for reading the image on the sheet fed from the sheet feeding unit. The attachment is configured to be separate from the image forming apparatus having the image forming unit as a center unit. Therefore, it is possible to attain flexibility in an expansion of the image forming system.

According to the present invention, in the image forming apparatus described above, the sheet determining means, reading control means, and sheet separating means are provided in the attachment as inserter devices. Therefore, it is possible to make a space for feeding and conveying the sheets small and simple.

### BRIEF DESCRIPTION OF THE DRAWINGS

FIG. 1 is a block diagram showing a whole configuration of an image forming apparatus according to the invention;

FIG. 2 is a cross sectional view showing an image forming apparatus according to the first embodiment of the invention;

FIG. 3 is a cross sectional view showing a sheet discharge unit (ejection part) in the image forming apparatus according to the first embodiment;

FIG. 4 is a cross sectional view showing an image forming apparatus according to the second embodiment of the invention;

FIG. 5 is a cross sectional view showing a sheet discharge unit (ejection part) in the image forming apparatus according to the second embodiment;

FIG. 6 is a cross sectional view showing an image forming apparatus according to the third embodiment of the invention;

FIG. 7 is a cross sectional view showing an image forming apparatus according to the fourth embodiment of the invention;

FIG. 8 is a block diagram showing a configuration of a control system in the image forming apparatus according to the invention;

FIG. 9 is a block diagram showing a configuration of an image forming system according to the invention; and

FIG. 10 is a block diagram showing a configuration of a conventional image forming apparatus.

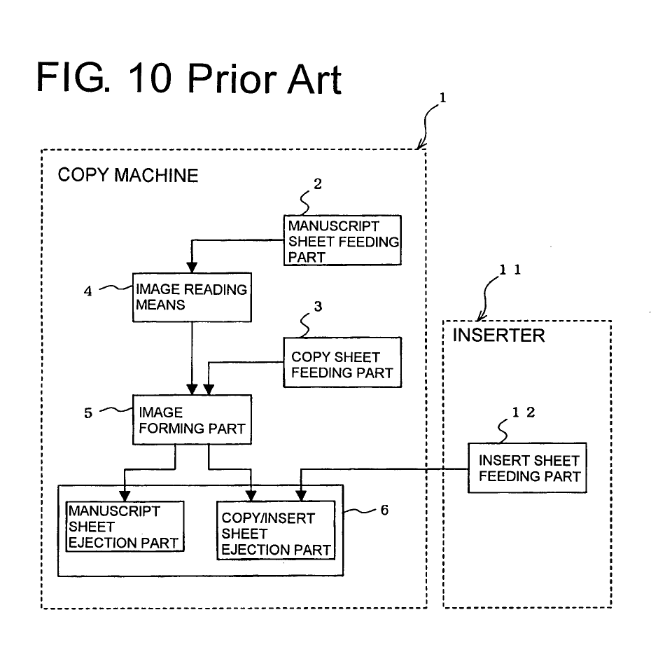

### DETAILED DESCRIPTION OF PREFERRED EMBODIMENTS

Hereunder, embodiments of the present invention will be described in detail with reference to the accompanying drawings.

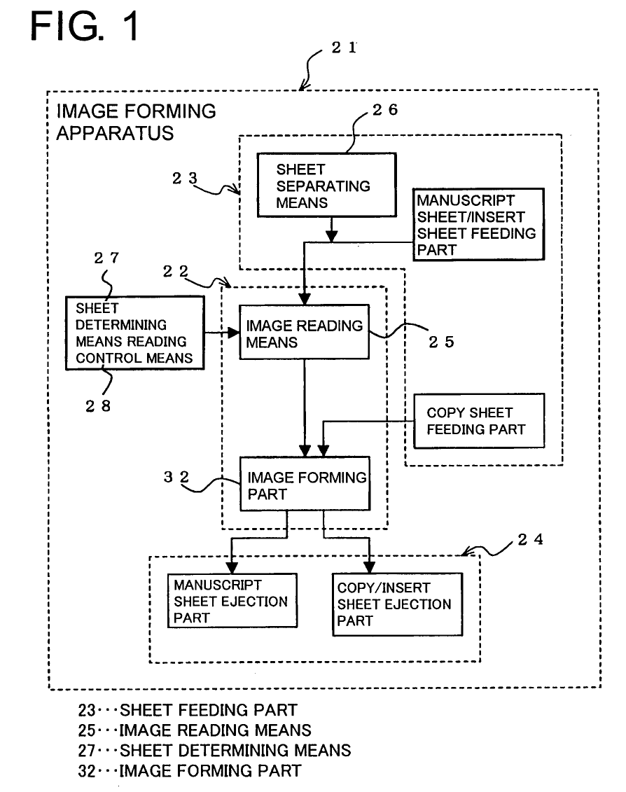

FIG. 1 shows a whole configuration of an image forming apparatus 21 according to the invention. The image forming apparatus 21 comprises an apparatus main unit 22 mainly including image reading means 25 for reading an image on a manuscript sheet and an image forming unit (part) 32 for transferring and forming the image on a copy sheet; a sheet feeding unit (part) 23 for feeding the manuscript sheet, an insert sheet such as a cover, an interleaf, or the like, and the copy sheet; and a sheet discharge unit (ejection part) 24 for inserting the insert sheet in between the copy sheets with the images thereon and for discharging the sheets.

The image forming apparatus 21 also comprises sheet separating means 26 for separating the sheets fed from a manuscript/insert-sheet feeding device in the sheet feeding unit 23 one by one; sheet determining means 27 for determining whether the sheet conveyed to the image reading means 25 is the manuscript sheet or the insert sheet; and reading control means 28.

The sheet determining means 27 employs the following methods for the function. In the first method, an operator determines the manuscript sheet or the insert sheet manually. In the second method, the image reading means 25 or exclusive reading means reads a mark printed on the manuscript sheet or the insert sheet beforehand for determining the manuscript sheet or the insert sheet.

In the first method, before the manuscript sheet is conveyed, the operator may push a button to indicate that the sheet is the manuscript. When the insert sheet is conveyed, the operator may release the manuscript indication, so that it is determined whether the conveyed sheet is the manuscript or the insert sheet. In the case where the manuscripts and insert sheets are mixed, the operator may use a predetermined button to indicate a location of the insert sheet so that it is determined whether the conveyed sheet is the manuscript or the insert sheet.

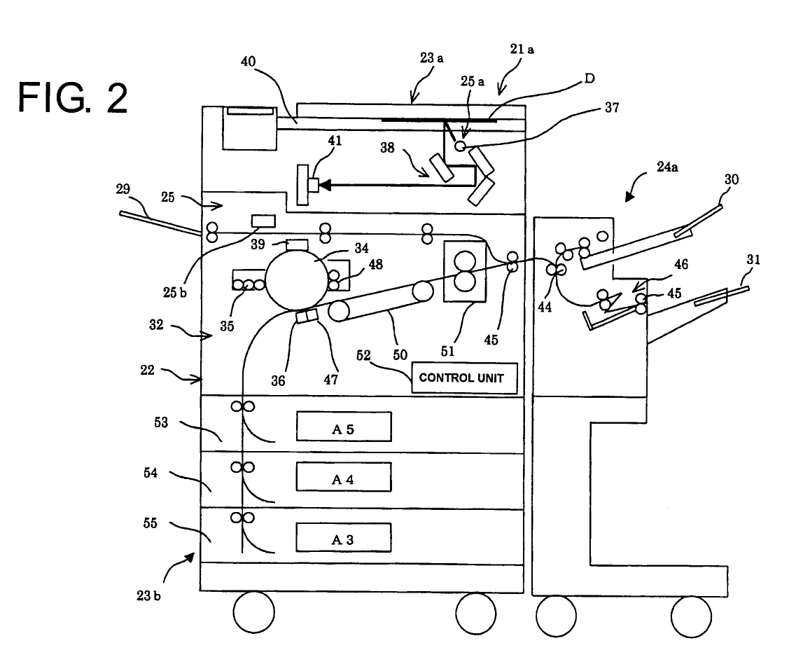

FIG. 2 shows an example of a configuration of the image forming apparatus 21 according to the first embodiment. An image forming apparatus 21a shown in FIG. 2 comprises the apparatus main unit 22 arranged at the center of the apparatus. The apparatus main unit 22 includes the image reading means 25 and an image forming unit 32. The first sheet feeding unit 23a is arranged at an upper portion of the apparatus for feeding the manuscript sheets or insert sheets. The second sheet feeding unit 23b is arranged at a lower portion of the apparatus for feeding the copy sheets. The sheet discharge unit 24 is arranged adjacent to the apparatus main unit 22.

The image reading means 25 in the apparatus main unit 22 comprises the first image reading means 25a of a moving type for reading a manuscript sheet D placed on a platen glass 40, and the second image reading means 25b of a stationary type for sequentially reading the manuscript sheet fed from a sheet feeding tray 29. The first image reading means 25a comprises a light source 37 for irradiating light on a surface of the manuscript sheet D on the platen glass 40 while moving; an optical lens group 38 for receive an image of light reflected from the surface of the manuscript sheet D; and an optical sensor (CCD) 41 for obtaining the image of light received by the optical lens group 38 to convert the image into an electric signal.

Similar to the first image reading means 25a, the second image reading means 25b comprises a light source for irradiating light on a surface of the manuscript sheet fed from the sheet feeding tray 29, and an optical sensor for obtaining an image of light reflected from the surface of the manuscript sheet to convert the image into an electric signal. The second image reading means is provided adjacent to the sheet feeding tray 29 in the apparatus main unit 22.

The image forming unit 32 comprises a cylindrical photosensitive drum 34 having an outer peripheral surface on which a latent image can be formed. Also, arranged around the photosensitive drum 34 are a primary charging device 39 for electrically charging the photosensitive drum 34 to form the latent image; a laser unit for outputting laser beams modulated in response to image data read and processed by the image reading means 25; a developer 35 for developing the electrostatic latent image formed on the photosensitive drum 34 to form a toner image; a transfer charging device 36 for electrically charging the toner image formed by the developer 35 to transfer the toner image to a copy sheet; a separation charging device 47 for electrically charging the copy sheet with polarity opposite to that of the transfer charging device 36 to separate the copy sheet from the photosensitive drum 34; and a cleaner 48 for cleaning the photosensitive drum 34.

A rollers is arranged at downstream of the photosensitive drum 34 and in the vicinity of the separation charging device 47, and an endless conveyor belt 50 is placed around the roller. The endless conveyor belt 50 is extended between the roller and a roller arranged in the vicinity of a fixing device 51 and including heat rollers or the like for heating the toner image formed on the sheet for fixing. A pair of ejection rollers 45 is arranged at downstream of the fixing device 51 for discharging the sheet with the image formed thereon from the image forming unit 32.

At the upper portion of the apparatus main unit 22, there are provided the platen glass 40 for placing the manuscript sheet D, and a touch panel for displaying a state of the apparatus main unit 22 or the like in accordance with information from a control unit 52. The operator can directly instruct an operation to the control unit 52 through the touch panel. Further, if necessary, an automatic sheet feeder (ADF) (not shown in FIG. 2) may be disposed above the platen glass 40 for feeding the manuscript sheet D to the platen glass 40.

The image reading means 25 comprises the sheet determining means 27 shown in FIG. 1 for determining the manuscript sheet and insert sheet fed from the sheet feeding tray 29, and the reading control means 28 for reading the image only when the sheet determining means 27 determines the manuscript sheet. With the sheet determining means 27 and the reading control means 28, it is possible to skip the reading of the insert sheet among the sheets conveyed even when the sheet feeding tray 29 feeds the manuscript sheets and insert sheets in a mixed state and there is only a single conveyance path extending from the sheet feeding tray 29, thereby facilitating the whole process.

The second sheet feeding unit 23b provided at the lower portion of the apparatus main unit 22 feeds the copy sheet, on which the image is transferred and formed. The second sheet feeding unit 23b is detachably mounted to the apparatus main unit 22, and comprises a cassette 53 for receiving A5 size sheets, a cassette 54 for receiving A4 size sheets, a cassette 55 for receiving A3 size sheets, and so on. A sheet size can be selected from a key input portion provided on an operation control unit (described later), or by pushing switches arranged on the respective cassettes 53, 54, 55 while confirming visually.

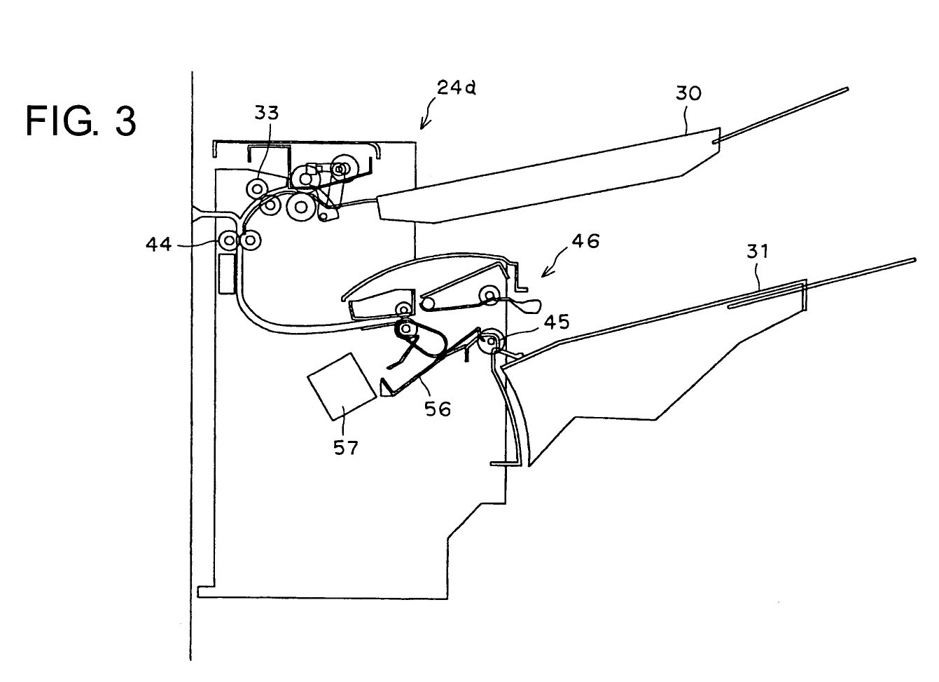

As shown in FIG. 3, the sheet discharge unit 24a provided adjacent and connected to the apparatus main unit 22 comprises a manuscript discharge tray 30 for receiving the manuscript sheets; a stack tray 31 for receiving the copy sheets with the images formed thereon and the insert sheets; a pair of conveyance rollers 44; and a pair of ejection rollers 45. These rollers feed the manuscript sheets, copy sheets, and insert sheets to the manuscript ejection tray 30 and the stack tray 31.

A sheet stack aligning unit 46 is provided in front of the stack tray 31 for aligning a sheet stack composed of the copy sheets with the images formed thereon, and the insert sheets such as covers, interleaves, or the like, inserted between the copy sheets, and for carrying out a stapling operation if necessary.

The sheet stack aligning unit 46 comprises a processing tray 56, a stapling device 57, and so on. The processing tray 56 sequentially receives the copy sheets with the images formed thereon and insert sheets while aligning edges of the sheets. The stapling device 57 performs a bundling operation when the sheet stack composed of a predetermined number of the sheets is received.

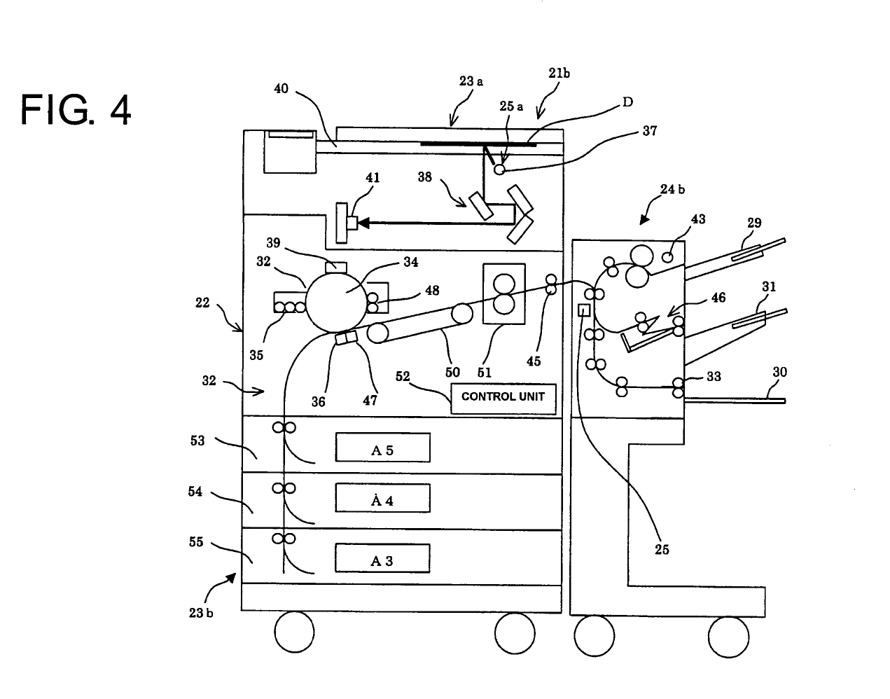

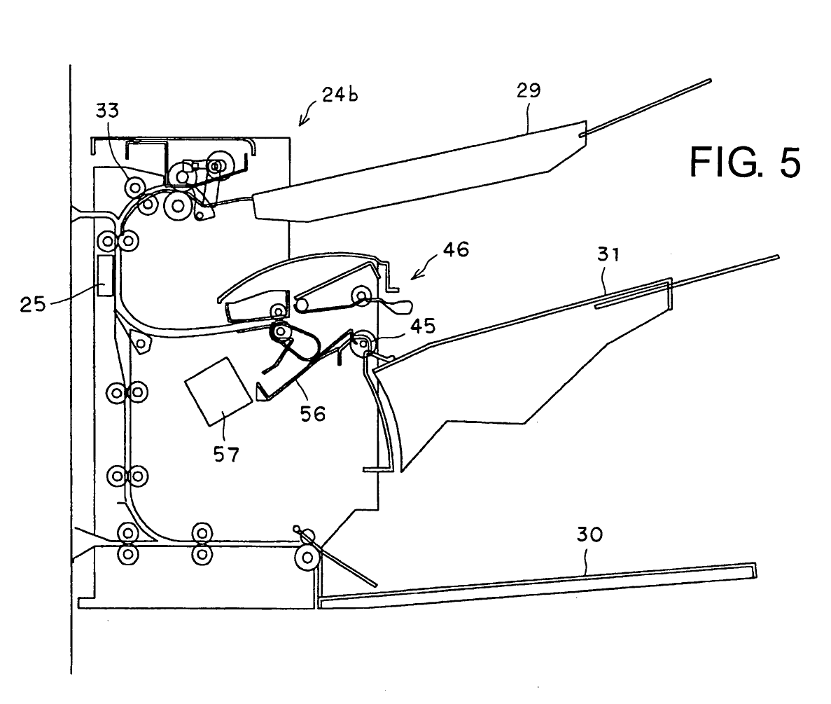

FIG. 4 shows an example of a configuration of an image forming apparatus 21b according to the second embodiment. As shown in FIG. 5, the image forming apparatus 21b comprises a sheet discharge unit 24b for aligning and feeding the copy sheets and insert sheets, and image reading means 25 provided in the sheet discharge unit 24b for reading the image while conveying the manuscript sheets and insert sheets. The sheet discharge unit 24b comprises a sheet feeding tray 29 for feeding the manuscript sheets and insert sheets; a stack tray 31 for aligning the copy sheets with the images formed thereon and the insert sheets inserted between the copy sheets, and for discharging the sheets for each predetermined unit; and a manuscript discharge tray 30 for receiving the manuscript sheets among the sheets fed from the sheet feeding tray 29.

In the image forming apparatus 21b having such an arrangement, the manuscript sheets and insert sheets are placed together on the sheet feeding tray 29. Then, a pickup roller 43 picks up the sheet one by one from the sheet feeding tray 29, and the image is read while the sheet passes in front of the image reading means 25 provided with the optical sensor such as CCD or the like.

After reading the manuscript sheets, the read image data is transmitted to the image forming unit 32 provided in the apparatus main unit 22. The image data is transferred and formed on the copy sheets fed from the cassettes 53, 54, 55, which feed the copy sheets of respective sizes. After the copy sheets are conveyed to the sheet discharge unit 24b, the copy sheets are temporarily loaded on a sheet stack aligning unit 46 to stand by there. The subsequent manuscript sheets are read for processing the image, and the copy sheets with the images formed thereon are successively loaded on the sheet stack aligning unit 46.

Similar to the sheet discharge unit 24a in the first embodiment, the sheet stack aligning unit 46 comprises a processing tray 56, a stapling device 57, and so on. The processing tray 56 successively receives the copy sheets with the images formed thereon and the insert sheets while aligning edges of the sheets. The stapling device 57 performs a bundling operation when the sheet stack composed of a predetermined number of the sheets is loaded.

When the insert sheet is fed from the sheet feeding tray 29, the sheet determining means 27 shown in FIG. 1 determines the sheet. The reading process at the image reading means 25 is skipped, and the insert sheet is discharged onto the sheet stack aligning unit 46. After the manuscript sheets and insert sheets on the sheet feeding tray 29 are fed, the copy sheets with the images formed by the image forming unit 32 are successively loaded on the sheet stack aligning unit 46. After the sheet stack aligning unit 46 aligns the edges of the sheets, or an process such as stapling or the like is performed, the sheets are discharged onto the stack tray 31.

The manuscript sheets are discharged onto the manuscript ejection tray 30 through a separate conveyance path. In the apparatus main unit 22, image reading means 25a of moving type is provided below the platen glass 40 for reading the manuscript sheet, which is bound and cannot be placed on the sheet feeding tray 29. The image reading means 25a and the image forming unit 32 have configurations same as those of the image forming apparatus 21a in the first embodiment shown in FIG. 2, and the explanation thereof is omitted.

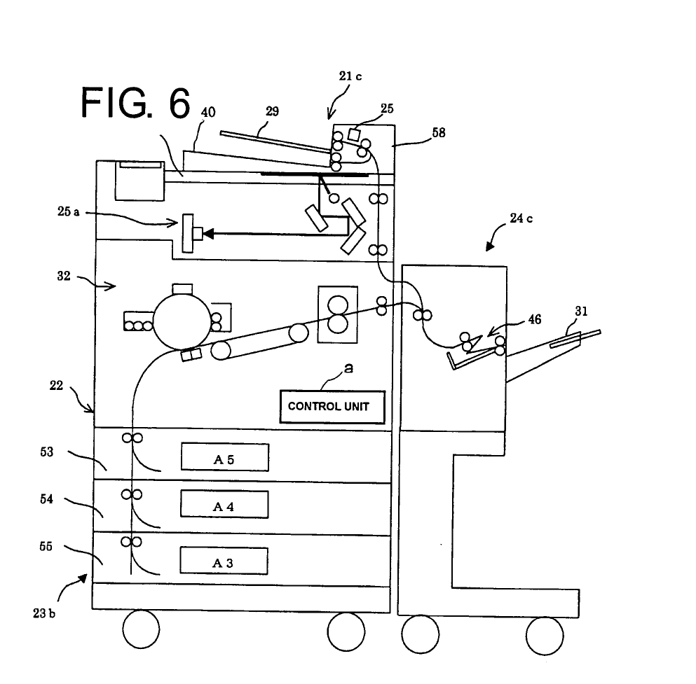

FIG. 6 shows a configuration of an image forming apparatus 21c according to the third embodiment. The image forming apparatus 21c is provided with an automatic sheet feeder (ADF 58) for feeding the manuscript sheets and insert sheets. The ADF 58 comprises a sheet feeding tray 29 for feeding the manuscript sheets and insert sheets; image reading means 25 provided with a CCD sensor for reading the image the manuscript sheet; and a manuscript discharge tray 30 for receiving the manuscript sheet.

In the image forming apparatus 21c with the configuration described above, the image reading means 25 provided in the ADF 58 reads the image while the manuscript sheets and insert sheets on the sheet feeding tray 29 are fed. The image data read by the image reading means 25 is transmitted to the image forming unit 32 in the apparatus main unit 22. After the read image data is transferred and formed on the copy sheets fed from the cassettes 53, 54, 55, which feed the copy sheets of respective sizes, the sheets are forwarded to a sheet discharge unit 24c. The sheets conveyed to the sheet discharge unit 24c are temporarily loaded on the sheet stack aligning unit 46. The subsequent manuscript sheets are read for processing the image, and the copy sheets with the images formed thereon are successively loaded on the sheet stack aligning unit 46, and then discharged collectively onto a stack tray 31. In a case where the ADF 58 is not mounted, the moving-type image reading means 25a reads the manuscript sheet placed on the platen glass 40.

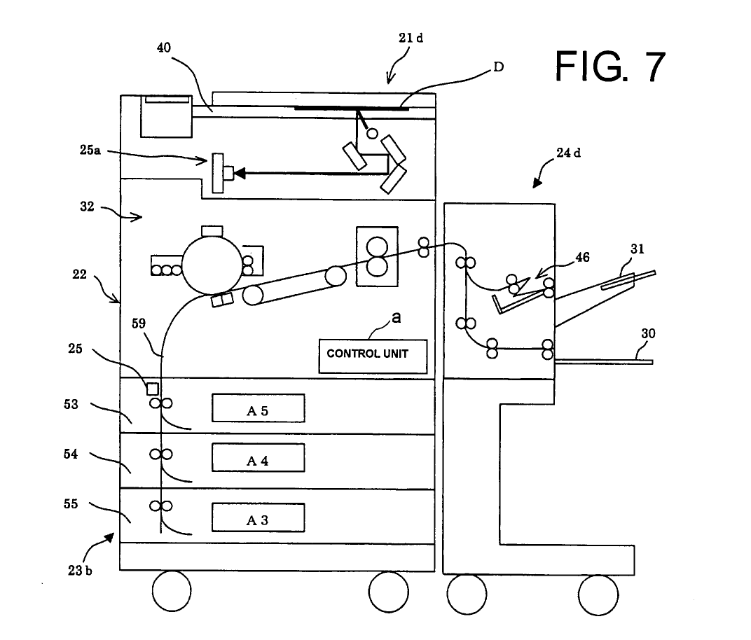

FIG. 7 shows an example of a configuration of an image forming apparatus 21d according to the fourth embodiment. The image forming apparatus 21d is provided with the second sheet feeding unit 23b for feeding the copy sheets. The second sheet feeding unit 23b has a sheet feeding unit for feeding the manuscript sheets and insert sheets, and the image reading means 25. The image reading means 25 is provided along a common conveyance path 59 extending toward the image forming unit 32 from the cassettes 53, 54, 55, which feed the copy sheets of respective sizes.

In the image forming apparatus 21d, the manuscript sheets are fed from sheet feeding trays arranged in the respective cassettes 53, 54, 55. After the image reading means 25 reads the images on the manuscript sheets, the image forming unit 32 transfers and forms the images on the copy sheets. The copy sheets are then forwarded and loaded on the sheet stack aligning unit 46 provided in a sheet discharge unit 24d.

The image reading means 25 is provided with the sheet determining means 27 and reading control means 28 in the same manner as in the embodiments described above. Accordingly, when the insert sheet is fed, the image reading and image processing processes are skipped. The insert sheet is loaded on the sheet stack aligning unit 46, and the process such as sheet stack aligning, stapling, or the like is carried out. The sheet discharge unit 24d is provided with the stack tray 31 and the manuscript discharge tray 30. A stack of the aligned sheets with the images formed thereon and having the insert sheets, such as covers, interleaves, or the like, is discharged onto the stack tray 31. The manuscript sheets are discharged onto the manuscript ejection tray 30 after the reading process.

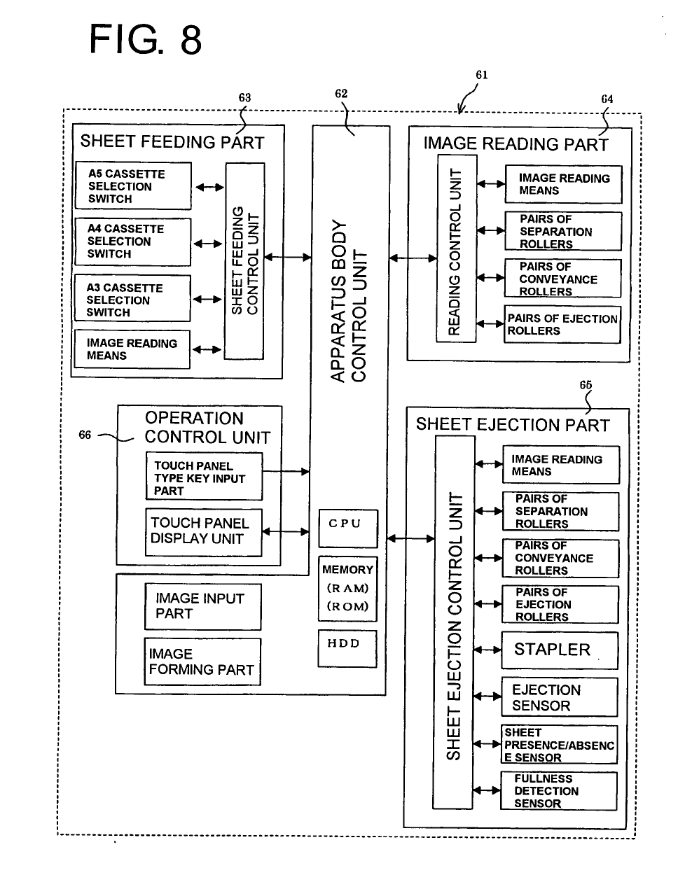

The image forming apparatuses 21a to 21d in the first to fourth embodiments are driven and controlled by a control system 61 shown in FIG. 8. The control system 61 comprises an apparatus main unit control unit 62 for controlling the apparatus main unit 22 to transfer and form the images; a sheet feeding part 63; an image reading part 64; a sheet discharge unit 65; and an operation control unit 66. The apparatus main unit control unit 62 comprises a CPU; and a memory such as RAM, ROM, or the like, or a high capacity hard disk (HDD), for storing various sets of data, programs, and so on. The apparatus main unit control unit 62 controls operations of respective units while communicating with independent sheet feeding control unit, reading control unit, and sheet discharge control unit, which are provided in the sheet feeding unit 63, the image reading part 64, and the sheet discharge unit 65.

In the sheet feeding unit 63, the apparatus main unit control unit 62 controls operations of feeding the manuscript sheets and insert sheets, selection of the cassettes from which the copy sheets are fed, and so on. In the image reading part 64, the apparatus main unit control unit 62 controls directions and speeds of the pair of the separation rollers, the pair of the conveyance rollers, and the pair of the discharge rollers. Also, in the sheet discharge unit 65, the apparatus main unit control unit 62 controls operations of various pairs of rollers for conveying the sheets, and sensors for aligning, stapling and conveying the sheets.

The operation control unit 66 comprises an interface part such as a touch panel type key input part, liquid crystal display, and so on. A state of each of the various operations and controls can be monitored through a liquid crystal monitor. The image reading means 25 is provided in the sheet feeding unit 63, the image reading part 64, and the sheet discharge unit 65. According to the embodiments shown in FIGS. 2 to 7, the image reading means 25 is provided in one or more of the sheet feeding unit 63, the image reading part 64, and the sheet discharge unit 65.

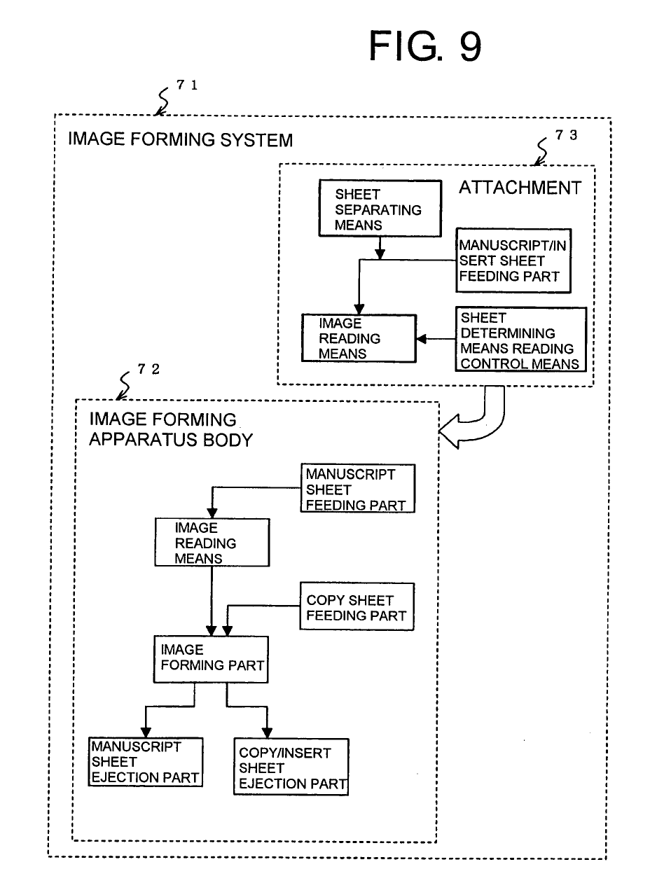

In the image forming apparatuses 21a, 21b, 21c, and 21d, the apparatus main unit 22, in which the sheet feeding unit and the sheet discharge unit are provided around the image forming unit 32, is provided with the sheet feeding means and image reading means for the insert sheets. As in an image forming system 71 shown in FIG. 9, the sheet feeding means and image reading means for the insert sheets can be provided in an attachment 73, such as ADF, finisher, or the like, attached to an image forming apparatus main unit 72.

Since the attachment 73 has these functions, it is possible to reduce a load on the image forming apparatus main unit 72 having the image forming unit. Further, it is easy to add necessary functions or delete them depending on a purpose or budget. For example, for making ordinary copies, it suffices to use only the image forming apparatus main unit 72. Only when the insert sheets are inserted for binding a book, the attachment 73 with additional functions is equipped. Further, it is possible to remove a failed part easily, thereby improving maintenance.

In the sheet feeding means for the insert sheets and the image reading means provided in the attachment, such as ADF, finisher, or the like, functions of the sheet determining means, reading control means, sheet separating means, or the like can be added.

As described above, the function of inserting the sheets is added by using a part of the sheet feeding means for the manuscripts and copy sheets and the image reading means provided in the image forming apparatus main unit. Therefore, it is possible to reduce a size and a cost of the image forming apparatus main unit.

The image reading means is provided in the automatic sheet feeding device, automatic sheet ejection device, and the like, in the image forming apparatus main unit. Therefore, it is possible to provide the image forming system for feeding and discharging the various types of sheets.

While the invention has been explained with the specific embodiments of the invention, the explanation is illustrative and the invention is limited only by the appended claims.

What is claimed is:

1. An image forming apparatus comprising:
a sheet feeding unit for feeding a sheet including a manuscript sheet and an insert sheet composed of a cover or an interleaf;
image reading means communicating with the sheet feeding unit for reading an image on the sheet fed from the sheet feeding unit;
an image forming unit electrically connected to the image reading means for forming the image read by the image reading means on a copy sheet; and
a sheet discharge unit for discharging the manuscript sheet, the copy sheet, and the insert sheet.

2. An image forming apparatus according to claim 1, further comprising sheet determining means for determining whether the sheet fed from the sheet feeding unit is the manuscript sheet or the insert sheet, and reading control means for controlling the image reading means to read the image only when the sheet determining means determines that the sheet is the manuscript sheet.

3. An image forming apparatus according to claim 2, wherein said sheet determining means includes operation means for selecting the manuscript sheet and the insert sheet among the sheets fed from the sheet feeding unit.

4. An image forming apparatus according to claim 1, wherein said sheet discharge unit includes a copy sheet discharge unit for discharging the copy sheet with the image formed by the image forming unit, an insert sheet conveyance path for guiding the insert sheet fed from the sheet feeding unit to the copy sheet discharge unit, a manuscript sheet discharge unit for discharging the manuscript sheet fed from the sheet feeding unit, and a manuscript sheet conveyance path for guiding the manuscript sheet fed from the sheet feeding unit to the manuscript sheet discharge unit.

5. An image forming apparatus according to claim 1, wherein said sheet discharge unit includes a copy sheet discharge unit for discharging the copy sheet with the image formed by the image forming unit, and a common conveyance path for guiding the manuscript sheet and the insert sheet fed from the sheet feeding unit to the copy sheet discharge unit.

6. An image forming apparatus according to claim 1, wherein said sheet feeding unit includes a sheet feeding tray for receiving the manuscript sheet and the insert sheet, and sheet separating means for separating the manuscript sheet or the insert sheet one by one.

7. An image forming system comprising:
an attachment including a sheet feeding unit for feeding a manuscript sheet and an insert sheet, and image reading means for reading an image on the manuscript sheet and the insert sheet fed from the sheet feeding unit; and
an image forming apparatus main unit attached to the attachment and having image forming means for forming the image on a copy sheet.

8. An image forming system according to claim 7, wherein at least one of said image forming apparatus main unit and said attachment includes sheet determining means for determining whether a sheet fed from the sheet feeding unit is the manuscript sheet or the insert sheet, and reading control means for controlling the image reading means to read the image only when the sheet determining means determines that the sheet is the manuscript sheet.

9. An image forming system according to claim 8, wherein said sheet determining means includes operation means for selecting the manuscript sheet and the insert sheet among the sheets fed from the sheet feeding unit.

10. An image forming system according to claim 7, wherein said attachment includes a sheet discharge unit for discharging the copy sheet with the image formed by the image forming means.

11. An image forming system according to claim 7, wherein said attachment includes image data conversion means for reading the image on the manuscript sheet and converting the image into image data.

12. An image forming system according to claim 7, wherein said attachment includes copy sheet feeding means for feeding the copy sheet to the image forming means.

13. An image forming system according to claim 7, wherein said sheet feeding unit includes a sheet feeding tray for receiving the manuscript sheet and the insert sheet, and sheet separating means for separating the manuscript sheet or the insert sheet one by one.

14. An image forming system according to claim 7, wherein said attachment includes a copy sheet discharge unit for discharging the copy sheet with the image formed by the image forming means, an insert sheet conveyance path for guiding the insert sheet fed from the sheet feeding unit to the copy sheet discharge unit, a manuscript sheet discharge unit for discharging the manuscript sheet fed from the sheet feeding unit, and a manuscript sheet conveyance path for guiding the manuscript sheet fed from the sheet feeding unit to the manuscript sheet discharge unit.

15. An image forming system according to claim 7, wherein said attachment includes a copy sheet discharge unit for discharging the copy sheet with the image formed by the image forming means, and a common conveyance path for guiding the manuscript sheet and the insert sheet fed from the sheet feeding unit to the copy sheet discharge unit.
